(19) United States
(12) Patent Application Publication
(10) Pub. No.: US 2009/0002578 A1
(43) Pub. Date: Jan. 1, 2009

(54) PROJECTION SYSTEM

(76) Inventors: Shigesumi ARAKI, Kanazawa-shi (JP); Kenji NAKAO, Kanazawa-shi (JP); Kazuhiro NISHIYAMA, Kanazawa-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/147,977

(22) Filed: Jun. 27, 2008

(30) Foreign Application Priority Data
Jun. 29, 2007 (JP) 2007-173229

(51) Int. Cl. G02F 1/133; G02F 1/1333

(52) U.S. Cl. 349/8; 349/72

(57) ABSTRACT

A projection system which has a plurality of liquid-crystal displays each includes a display panel having a plurality of OCB-mode liquid-crystal pixels, and a control unit configured to control the display panel, and which synthesizes images of different colors, modulated by the display panels, thereby to display a color image, wherein each of the liquid-crystal displays includes a temperature sensor, and the control unit of each liquid-crystal display controls at least one condition of driving the display panel in accordance with the temperature detected by any one of the temperature sensors.

### CROSS-REFERENCE TO RELATED APPLICATIONS

This application is based upon and claims the benefit of priority from prior Japanese Patent Application No. 2007-173229, filed Jun. 29, 2007, the entire contents of which are incorporated herein by reference.

### BACKGROUND OF THE INVENTION

1. Field of the Invention

The present invention relates to a projection system. More particularly, the invention relates to a projection system that uses an OCB-mode liquid-crystal display.

2. Description of the Related Art

Liquid-crystal displays are widely used as display devices in computers, car navigation systems and television receivers. Most liquid-crystal displays have a liquid-crystal display panel, a backlight, and a display control circuit. The liquid-crystal display panel includes a matrix array of liquid-crystal pixels. The backlight illuminates the liquid-crystal display panel. The display control circuit controls the liquid-crystal display panel and the backlight. The liquid-crystal display panel comprises an array substrate, a counter-substrate, and a liquid-crystal layer interposed between the array substrate and the counter-substrate.

The array substrate has a plurality of pixel electrodes, a plurality of gate lines, a plurality of source lines, and a plurality of switching elements. The pixel electrodes are arranged in the form of a matrix. The gate lines extend parallel to one another, along the rows of pixel electrodes. The source lines extend parallel to one another, along the columns of pixel electrodes. The switching elements are arranged near the intersections of the gate lines and the source lines. Each switching element is, for example, a thin-film transistor (TFT), and applies the potential on one source line to one pixel electrode when one gate line is driven. On the counter-substrate, a common electrode is provided, facing the pixel electrodes arranged on the array substrate. Each pixel electrode, the common electrode, and a pixel region (i.e., a part of the liquid-crystal layer, which lies between the pixel electrode and common electrode) constitute a pixel. The alignment of the liquid molecules in the pixel region is controlled by the electric field generated between the pixel electrode and the common electrode. The display control circuit includes a gate driver that drives the gate lines, a source driver that drives the source lines, and a controller circuit that controls the gate diver, source driver and backlight.

A liquid-crystal display for use in a television receiver that display mainly moving images has a liquid-crystal display panel of OCB mode, in which the liquid molecules exhibit good response characteristics. In this liquid-crystal display panel, the liquid-crystal layer assumes a splay alignment before power is supplied to the panel. In other words, the liquid-crystal molecules almost lie down before power is supplied to the liquid-crystal display panel, because the alignment films provided on the pixel electrodes and common electrode, respectively, have been rubbed parallel to each other. The liquid-crystal display panel employs an initial transition sequence, in which a relatively intense electric field applied upon supply of power in the initial process changes the alignment of liquid-crystal molecules, from splay alignment to bend alignment before the panel starts displaying images.

As mentioned above, the liquid-crystal layer assumes the splay alignment before power is supplied to the panel. This is because the splay alignment is more stable than the bend alignment in terms of energy, as long as no voltage is applied to drive the liquid-crystal. The alignment of liquid-crystal of this type tends to change from bend alignment back to splay alignment if no voltage has long been applied to the panel or if a voltage equal to or lower than so low a level that energy of splay alignment and the energy of bend alignment are comparable is applied to the panel for a long time. The splay alignment influences the viewing angle of the panel more greatly than the bend alignment.

In order to prevent the alignment of the liquid-crystal layer, from bend alignment to splay alignment, a drive method has hitherto been employed, in which a high voltage is applied to the liquid crystal for a fraction of the frame period during which one frame of image is displayed. In the case of a normally white liquid-crystal panel, this voltage corresponds to the pixel voltage that achieves black display. The drive method is therefore called “black insertion drive” (see Jpn. Pat. Appln. KOKAI Publication No. 2002-202491).

Any liquid-crystal display of OCB mode operates in birefringence mode. Therefore, the voltage applied to the panel is controlled in accordance with the retardation of the liquid-crystal or other material which varies with temperature. Hence, the initial transition sequence and the black insertion drive, both mentioned above, are controlled in accordance with the temperature.

In any three-plate projection system has three liquid-crystal panels for red (R), green (G) and blue (B), respectively, the three liquid-crystal panels should be controlled independently, in terms of temperature, if the liquid-crystal display of OCB mode is used at a broad temperature distribution.

### BRIEF SUMMARY OF THE INVENTION

A projection system according to an aspect of this invention has a plurality of liquid-crystal displays each comprising a display panel having a plurality of OCB-mode liquid-crystal pixels, and a control unit configured to control the display panel, and which synthesizes images of different colors, modulated by the display panels, thereby to display a color image, wherein each of the liquid-crystal displays includes a temperature sensor, and the control unit of each liquid-crystal display controls at least one condition of driving the display panel in accordance with the temperature detected by one of the temperature sensors.

A projection system according to an aspect of this invention has a plurality of liquid-crystal displays each comprising a display panel having a plurality of OCB-mode liquid-crystal pixels, and a control unit, and which synthesizes images of different colors, modulated by the display panels, thereby to display a color image, wherein the control unit of each liquid-crystal display controls at least one condition of driving the display panel in accordance with the temperature detected by a temperature sensor provided outside the liquid-crystal displays.

A projection system according to an aspect of this invention has a plurality of liquid-crystal displays each comprising a display panel having a plurality of OCB-mode liquid-crystal pixels, and a control unit configured to control the display panels, and which synthesizes images of different colors, modulated by the display panels, thereby to display a color image, wherein one of the liquid-crystal displays includes a temperature sensor, and the control unit of each liquid-crystal display controls at least one condition of driving the display panel in accordance with the temperature detected by the temperature sensor.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram showing the schematic circuit configuration of one of the liquid-crystal displays used in a three-plate projection system according to the present invention;

FIG. 2 is a diagram schematically showing the source driver incorporated in the liquid-crystal display;

FIG. 3 is a diagram showing, in detail, the sectional structure of the liquid-crystal display panel of the display;

FIG. 4 is a diagram explaining an image displaying method performed in a three-plate, transmission-type projection system;

FIG. 5 is a diagram explaining a three-plate independent control method;

FIG. 6 is a diagram explaining a G-panel sensor control method;

FIG. 7 is a diagram explaining a high-temperature (low-temperature) sensor control method;

FIG. 8 is a diagram explaining a set sensor control method;

FIG. 9A is a table representing the compatibility various control methods may have with various control objects, in a first environment;

FIG. 9B is a table representing the compatibility various control methods may have with various control objects, in a second environment;

FIG. 9C is a table representing the compatibility various control methods may have with various control objects, in a third environment;

FIG. 9D is a table representing the compatibility various control methods may have with various control objects, in a fourth environment;

FIG. 10 is a diagram showing the configuration of a liquid-crystal display for use in a projection system;

FIG. 11A is a diagram showing a first relationship the black insertion ratio has with the temperature;

FIG. 11B is a diagram showing a second relationship the black insertion ratio has with the temperature;

FIG. 11C is a diagram showing a third relationship the black insertion ratio has with the temperature;

FIG. 11D is a diagram showing a fourth relationship the black insertion ratio has with the temperature;

FIG. 12 is a diagram representing the relationship between temperature and transmittance;

FIG. 13 is a diagram representing luminance-voltage characteristic data, i.e., the relationship between the luminance of an image displayed by OCB-mode liquid-crystal and the voltage applied to the OCB-mode liquid-crystal; and

FIG. 14 is a diagram representing the relationship between the panel temperature and the transition time.

### DETAILED DESCRIPTION OF THE INVENTION

An embodiment of the present invention will be described in detail, with reference to the accompanying drawings.

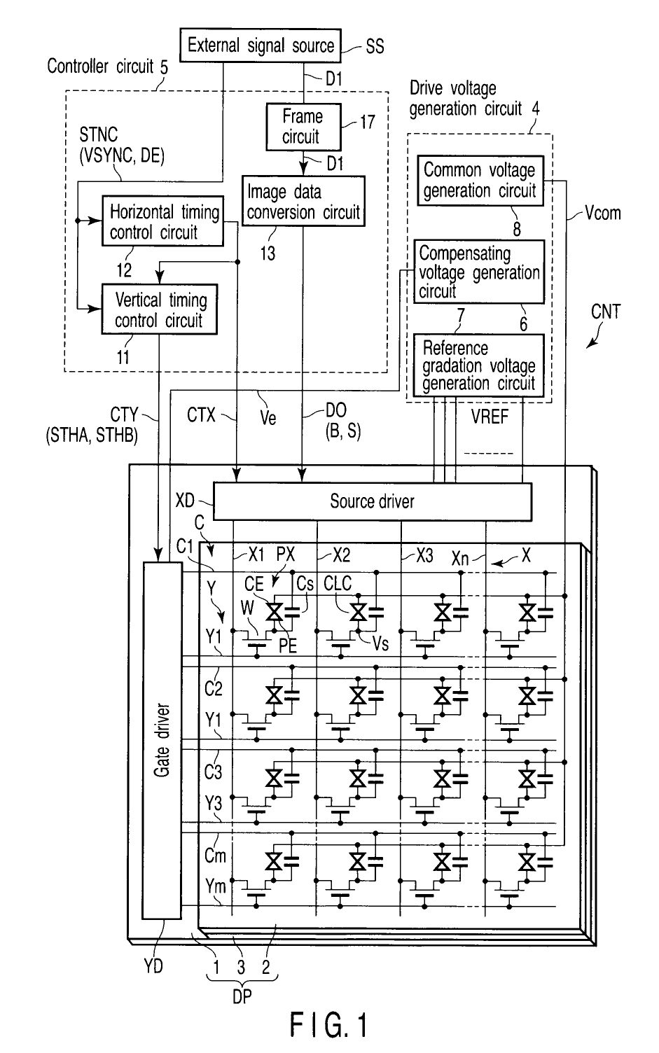

FIG. 1 is a diagram showing the schematic circuit configuration of one of the liquid-crystal display used in a three-plate projection system according to this invention.

The liquid-crystal display comprises a liquid-crystal display panel DP and a display control circuit CNT. The display control circuit CNT is configured to control the liquid-crystal display panel DP.

The liquid-crystal display panel DP comprises an array substrate 1, and a counter-substrate 2, and a liquid-crystal layer 3 interposed between the array substrate 1 and the counter-substrate 2. The liquid-crystal layer 3 contains liquid-crystal whose alignment changes from splay alignment to bend alignment to achieve normally white display and whose alignment is prevented from the reverse transition from bend alignment to splay alignment by applying a voltage for achieving black display periodically.

The display control circuit CNT controls the transmittance of the liquid-crystal display panel DP in accordance with the liquid-crystal drive voltage applied to the liquid-crystal layer 3, or applied between the array substrate 1 and counter-substrate 2. The transition from splay alignment to bend alignment is accomplished by applying a relatively intense electric filed to the liquid-crystal during the initializing process the display control circuit CNT performs upon supply of power.

A transparent insulating substrate GL is provided on the array substrate 1. On the transparent insulating substrate GL, a plurality of pixel electrodes PE are arranged, almost in the form of a matrix. A plurality of gate lines Y (Y1 to Ym) are arranged parallel to one another, extending along rows of pixel electrodes PE. A plurality of source lines X (X1 to Xn) are arranged parallel to one another, extending along columns of pixel electrodes PE.

A plurality of pixel switching elements W are arranged near the intersections of the gate lines Y and the source lines X. Each switching element w is a thin-film transistor, whose gate is connected to a gate line Y and whose source-drain path is connected between a source line x and a pixel electrode PE. When a drive voltage is applied to the gate through the gate line Y, electrical conduction develops between the source line X and the pixel electrode PE.

The pixel electrodes PE and the common electrode CE are made of transparent electrode material such as ITO. The pixel electrodes PE are covered with an alignment film AL. The common electrode CE is covered with an alignment film AL, too. Each pixel electrode PE, the common electrode CE, and a pixel region (i.e., a part of the liquid-crystal layer, whose molecule alignment corresponds to the electric filed between the pixel electrode PE and common electrode CE) constitute a liquid-crystal pixel PX.

Each of the liquid-crystal pixels PX has a liquid-crystal capacitance CLC between the pixel electrode PE and the common electrode CE. A plurality of storage capacitance lines Cl to Cm are provided, each capacitively coupled to the pixel electrodes PE of the liquid-crystal pixels PX of the associated row. Thus, storage capacitors Cs are provided. The storage capacitors Cs have capacitance that is much larger than the parasitic capacitance of the pixel switching elements W.

The display control circuit CNT comprises a gate driver YD, a source driver XD, a backlight driving unit LD, a drive voltage generation circuit 4, and a controller circuit 5.

The gate driver YD drives the gate lines Y to Ym, one after another, so that the switching elements W may be rendered conducting in units of rows. The source driver XD applies a pixel voltage Vs to the source lines X1 to Xn during the conducting period of the switching elements W by driving each of corresponding gate lines Y. The drive voltage generation circuit 4 generates a drive voltage for driving the liquid-crystal display panel DP. The controller circuit 5 controls the gate driver YD and the source driver XD.

The drive voltage generation circuit 4 may include a capacitive-coupling-driving (CCD) method having a compensating voltage generation circuit 6 that generates a compensating voltage Ve to be applied to the storage capacitance lines C. The drive voltage generation circuit 4 further includes a reference gradation voltage generation circuit 7 and a common voltage generation circuit 8. The reference gradation voltage generation circuit 7 generates a prescribed number of reference gradation voltages VREF, which are used in the source driver XD. The common voltage generation circuit 8 generates a common voltage to be applied to the counter-electrode CT.

The controller circuit 5 includes a vertical timing control circuit 11, a horizontal timing control circuit 12, an image data conversion circuit 13, and a frame circuit 17.

The vertical timing control circuit 11 generates a control signal CTY for controlling the gate driver YD, from a synchronizing signal SYNC (VSYNC, DE) input from an external signal source SS. The horizontal timing control circuit 12 generates a control signal CTX for controlling the source driver XD, from the synchronizing signal SYNC (VSYNC, DE) input from the external signal source SS.

The frame circuit 17 extracts image data for a specific color from image data DI′ input to the pixels PX from the external signal source SS. The image data thus extracted is output to the image data conversion circuit 13.

The image data conversion circuit 13 performs, for example, black insertion, double-speed conversion on the image data input from the frame circuit 17. Performing the this conversion, the circuit 13 generates pixel data items DO.

The image data is composed of a plurality of pixel data items DI for the respective liquid-crystal pixels PX. The image data is updated every one-frame display period (i.e., every vertical scanning period). The control signal CTY is supplied to the gate driver YD. The control signal CTX is supplied to the source driver XD, together with the pixel data items DO generated by the image data conversion circuit 13. The control signal CTY causes the gate driver YD to drive the gate lines Y, one after another, as described above. The control signal CTX causes the source driver XD to allocate the pixel data items DO generated by the circuit 13 for one row and output in series, to the source lines X, respectively, and to designate polarities of the pixel data items DO.

The gate driver YD is constituted by, for example, a shift register circuit, and configured to select at least one gate line Y. The gate driver YD outputs two types of gate pulses, one type for achieving black insertion, and the other type for accomplishing gradation display.

To this end, the control signal CTY supplied to the gate driver YD includes a first start signal (gradation display start signal) STHA, a second start signal (black insertion start signal) STHB, a clock signal, and an output enable signal.

The first start signal (i.e., gradation display start signal) STHA controls the timing of starting the gradation display. The second start signal (i.e., black insertion start signal) STHB controls the timing of starting the black insertion. The clock signal shifts these start signals STHA and STHB in the shift register circuit. The output enable signal controls the outputting of drive signal to the gate lines Y1 to Ym that are sequentially selected in groups or selected altogether at a time by the shift register in accordance with the positions the start signals STHA and STHB assume in the shift register circuit.

On the other hand, the control signal CTX contains a start signal, a clock signal, a load signal, and a polarity signal.

Controlled by the control signal CTY, the gate driver YD selects two sets of gate lines Y1 to Ym during each one-frame display period, one set for gradation display and the other set for black insertion, and applies an on-voltage to the selected gate lines Y. The on-voltage is a drive signal that turns on the pixel switching elements W of each row for one horizontal scanning period H. When the image data conversion circuit 13 performs the black insertion, double-speed conversion, it converts the input image data DI for one row, to black insertion fixed pixel data B for one row and gradation display variable pixel data S for one row. Note that the black insertion fixed pixel data B becomes output pixel data items DO every horizontal scanning period H.

The gradation display variable pixel data S represents the same gradation value as the image data DI represents. The black insertion fixed pixel data B represents a gradation value for the black display. The black insertion fixed pixel data B and gradation display variable pixel data S, both associated with one row, are output in series from the image data conversion circuit 13, each during half the horizontal scanning period (that is, during period H/2). Referring to the reference gradation voltages VREF generated by the reference gradation voltage generation circuit 7, the source driver XD converts the pixel data B and pixel data S to pixel voltage Vs. The pixel voltage Vs is applied to the source lines X1 to Xn.

The pixel voltage Vs based on the common voltage Vcom applied to the common electrode CE is applied to the pixel electrodes PE. The pixel voltage Vs is inverted in polarity with respect to the common voltage Vcom, so as to achieve, for example, frame inversion driving scheme and line inversion driving scheme.

The compensating voltage Ve is applied to the storage capacitance lines C associated with the gate lines Y connected to the switching elements W for one row, when these switching elements W are rendered non-conducting. Thus, the compensating voltage Ve may perform capacitive-coupling-driving, compensating for a fluctuation of the pixel voltage Vs due to the parasitic capacitance of the switching elements W.

The gate driver YD may apply an on-voltage to, for example, the gate line Y1, turning on all pixel switching elements W connected to the gate line Y1. In this case, the pixel voltage Vs on the source lines X1 to Xn is applied via these pixel switching elements W to the associated pixel electrodes PE and associated storage capacitors Cs, at one end thereof.

Then, the gate driver YD immediately output an off-voltage to the gate line Y1, rendering these pixel switching elements W non-conducting.

After then, the gate driver YD outputs the compensating voltage Ve generated by the compensating voltage generation circuit 6, to the storage capacitance line C1 associated with the gate line Y1. When these pixel switching elements W are rendered non-conducting, the compensating voltage Ve reduces the electric charge extracted from the pixel electrodes PE by the parasitic capacitance of the pixel switching elements W. Thus, the fluctuation of the pixel voltage Vs, i.e., field-through voltage ΔVp, is almost cancelled.

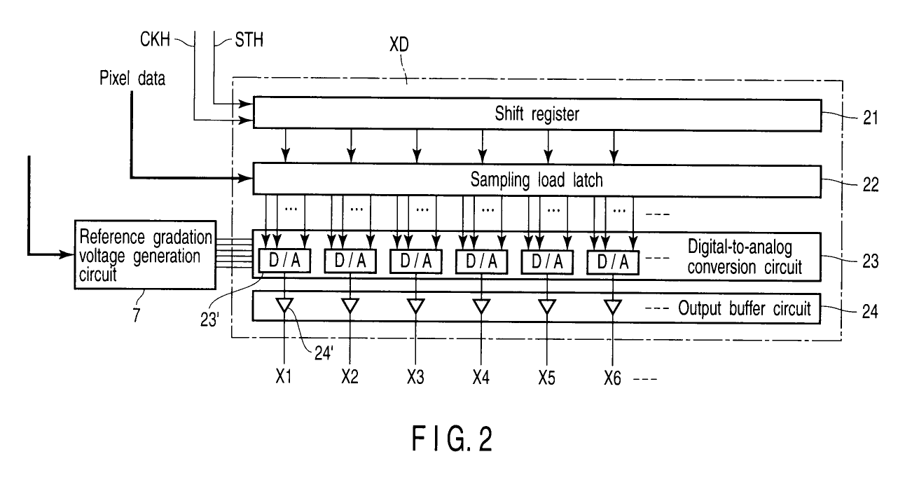

FIG. 2 is a diagram schematically showing the source driver XD.

The source driver XD includes a shift register 21, a sampling load latch 22, a digital-to-analog conversion circuit 23, and an output buffer circuit 24.

The control signal CTX contains a horizontal start signal STH and a horizontal clock signal CKH. The horizontal start signal STH controls the start timing of acquiring pixel data for one row. The horizontal clock signal CKH shifts a horizontal start signal STH in the shift register 21.

The shift register 21 shifts the horizontal start signal STH in synchronization with the horizontal clock signal CKH, controlling the timing of performing serial-to-parallel transformation on the pixel data items DO. Controlled by the control of the shift register 21, the sampling load latch 22 latches the pixel data items DO for the one-line pixels PX, in series, and outputs these pixel data items DO in parallel. The digital-to-analog conversion circuit 23 converts the pixel data items DO to pixel voltages, i.e., analog pixel voltages. The output buffer circuit 24 receives analog pixel voltages from the digital-to-analog conversion circuit 23 and output them to the source lines X1 to Xn. The digital-to-analog conversion circuit 23 is configured to refer to the reference gradation voltages VREF generated by the reference gradation voltage generation circuit 7.

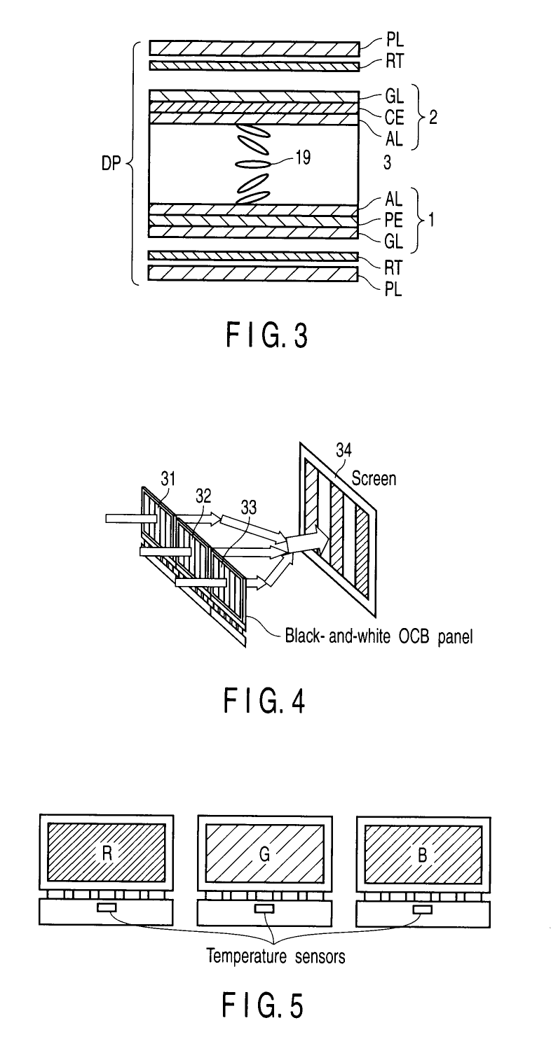

FIG. 3 is a diagram showing, in detail, the sectional structure of the liquid-crystal display panel DP.

The array substrate 1 includes a transparent insulating substrate GL made of glass, a plurality of pixel electrodes PE formed on the transparent insulating substrate GL, and an alignment film AL formed on the pixel electrodes PE. The counter-substrate 2 includes a transparent insulating substrate GL made of glass, a common electrode CE, and an alignment film AL formed on the common electrode CE. The liquid-crystal layer 3 has been prepared by filling liquid crystal in the gap between the counter-substrate 2 and the array substrate 1.

As shown in FIG. 3, the liquid-crystal molecules 19 are splay aligned. Nonetheless, the liquid-crystal molecules 19 are bend aligned when the energized. The liquid-crystal display panel DP comprises a pair of retardation films RT and a pair of polarizers PL. One retardation film RT is provided on the outer side of the array substrate 1, and the other retardation film RT on the outer side of the counter-substrate 2. The polarizers PL are arranged on the outer sides of the retardation films RT, respectively.

The alignment film AL provided at the array substrate 1 and the alignment film AL provided at the counter-substrate 2 have been rubbed parallel to each other. As a result, the pre-tilt angle of the liquid-crystal molecules is set to about 10°.

The objects on which OCB-mode liquid crystal performs temperature control will be described below.

### (1) Black Insertion

As described above, the alignment of the OCB-mode liquid crystal gradually changes from a bend-aligned state to a splay-aligned state, as it is applied with a relatively low voltage. This phenomenon is called “reverse transition.” In the normally white mode, the reverse transition can be prevented if a voltage corresponding to black is applied to each pixel, in addition to an image signal periodically supplied to the pixel. Therefore, one-frame displaying period consists of a display period of supplying the image signal to the pixel, and a black insertion period of applying the voltage corresponding to black to the pixel. The ratio of the black insertion period to the one-frame displaying period is called “black insertion ratio.”

The higher the temperature, the more readily the liquid-crystal molecules will move. Hence, the reverse transition may easily occur. That is, the alignment is changed from bend alignment to splay alignment. In view of this, it is desirable to increase the black insertion ration if the temperature rises, and to decrease the black insertion ration if the temperature falls, thereby to maintain the bend alignment and ultimately to display a high-quality image.

### (2) Flicker

Flicker is a wavering motion of an image on the screen. An image appears to waver when light blinks at a frequency equal to or lower than a specific value. In most cases, an image blinking the screen at 60 Hz is not perceived as flickering. However, such an image may appear to flicker, due to a phenomenon of the potential fluctuation of the pixel voltage.

To prevent this phenomenon, the counter-voltage is changed, altering the characteristic of each TFT used. Since the characteristic of the TFT depends on the temperature, the counter-voltage is changed in accordance with the temperature.

### (3) Black Display Voltage

The lower the temperature, the smaller the difference Δn in refraction index between liquid-crystal materials will be. As a result, the higher the temperature, the lower is the voltage (best black display voltage) which can accomplish the best black display. Hence, in the case that the black display voltage corresponds to the normal temperature, the transmittance increases, and the contrast decreases. Thus, the voltage to apply to the liquid crystal to achieve black display must be gradually lowered as the temperature of the liquid-crystal display panel DP rises, in order to suppress the contrast decrease.

### (4) Gamma Characteristic

The relationship observed in a display between the input signal and the display luminance is called the “gamma characteristic.” The error of transmittance balance between red, green and blue, resulting from the change in temperature, is controlled to maintain the color balance. More specifically, a correction algorithm or table based on the temperature as a parameter is applied, eliminating the transmittance balance error and ultimately correcting the gamma characteristic.

### (5) Transition Sequence

In the initializing process that starts upon supply of power, the alignment of the OCB liquid crystal must be changed from splay alignment to bend alignment. To this end, all gate lines of the liquid-crystal display panel are selected at the same time, rendering all switching elements conducting, the prescribed pixel voltage is then applied to all pixel electrodes through the switching elements, and the common voltage is applied to the common electrode. A transition voltage is thereby applied between the common electrode and all pixel electrodes.

The transition voltage is the potential difference between the common electrode and the pixel electrodes, from which an intense electric field is generated to cause a transition from splay alignment to bend alignment. After the initializing process, all gate lines of the liquid-crystal display panel are selected sequentially for performing a normal displaying operation.

When the temperature falls, the viscosity of the liquid crystal increases, inevitably reducing the speed with which the liquid-crystal alignment changes from splay alignment to bend alignment. In order to promote the initial transition, a control is performed to change the transition voltage or the time of applying the transition voltage in accordance with the temperature.

A method of driving the three-plate, transmission-type projection system will be explained with reference to FIG. 4.

The light emitted from a light source is split into, for example, a red light beam, a green light beam and a blue light beam by an illumination optical system (not shown) that comprises a color separating mirror.

The three light beams, provided by splitting the light, are applied to three transmission-type liquid-crystal panels 31, 32 and 33, respectively. The transmission-type liquid-crystal panels 31, 32 and 33 modulate the light beams with the image signals supplied to the panels 31, 32 and 33. The light beams thus modulated are synthesized by a color synthesizing optical element (not shown), providing a synthesized light beam. The synthesized light beam is projected to a screen 34 through a projection lens (no shown). A color image is thereby displayed on the screen 34.

As shown in FIG. 4, the transmission-type liquid-crystal panels 31, 32 and 33 are arranged, each spaced from another, in the projection system. Hence, they are not always at the same temperature. It is therefore important all or one of the panels 31, 32 and 33 should have a temperature sensor and that the temperature control should be executed in accordance with the temperature detected by the sensor or the temperatures detected by the sensors.

How a temperature sensor or sensors are secured and how the temperature control of the panels 31, 32 and 33 is executed will be explained below.

FIG. 5 is a diagram explaining a three-plate independent control method. In this method, three temperature sensors are attached to the transmission-type liquid-crystal panels 31, 32 and 33, respectively. The temperature control of the three panels 31, 32 and 33 is executed independently of one another.

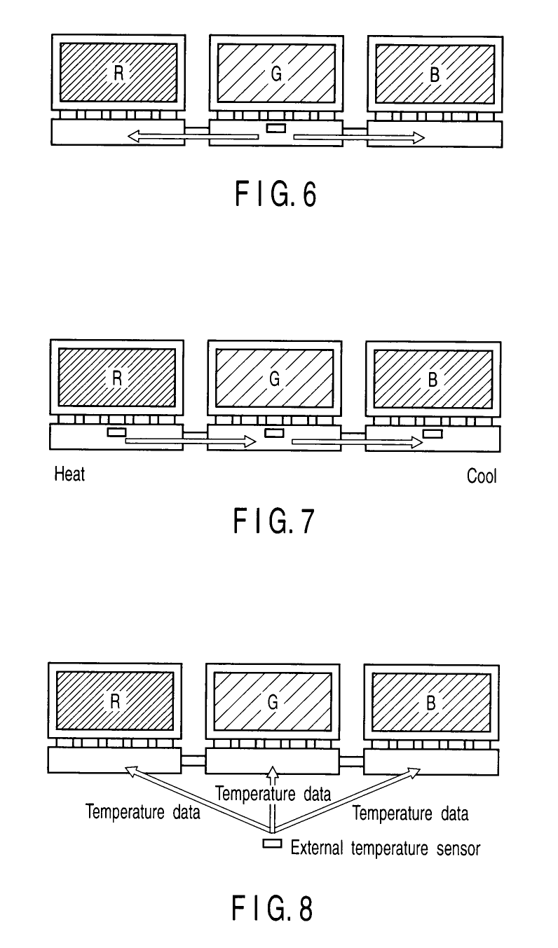

FIG. 6 is a diagram explaining a G-panel sensor control method. In this method, a temperature sensor is attached to only the transmission-type liquid-crystal panel 32 that displays a green (G) image. The temperature control of the three panels 31, 32 and 33 is executed in accordance with the temperature detected by the temperature sensor attached to the liquid-crystal panel 32.

FIG. 7 is a diagram explaining a high-temperature (low-temperature) sensor control method. In this method, three temperature sensors are attached to the transmission-type liquid-crystal panels 31, 32 and 33, respectively. Of the temperatures detected by the three sensors, the highest is used for temperature control of the three panels 31, 32 and 33.

FIG. 8 is a diagram explaining a set sensor control method. In this method, no temperature sensors are attached to the transmission-type liquid-crystal panels 31, 32 and 33. A temperature sensor is provided outside the liquid-crystal panels 31, 32 and 33. The temperature detected by the temperature sensor is used for the temperature control of the three panels 31, 32 and 33.

The inventors hereof have studied these control methods in an attempt to determine which method is most desirable to control the objects in each of four environments A, B, C and D.

In environment A, the temperature distribution is broad, and the temperature changes are large. In environment B, the temperature distribution is broad, but the temperature changes are small. In environment C, the temperature distribution is narrow, but the temperature changes are large. In environment D, the temperature distribution is narrow, and the temperature changes are small.

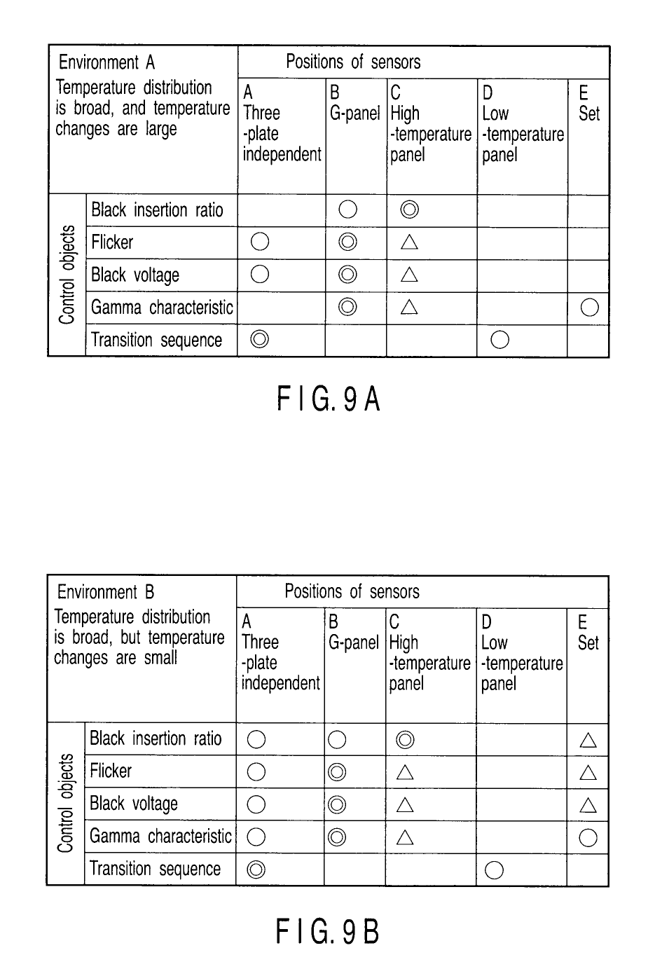

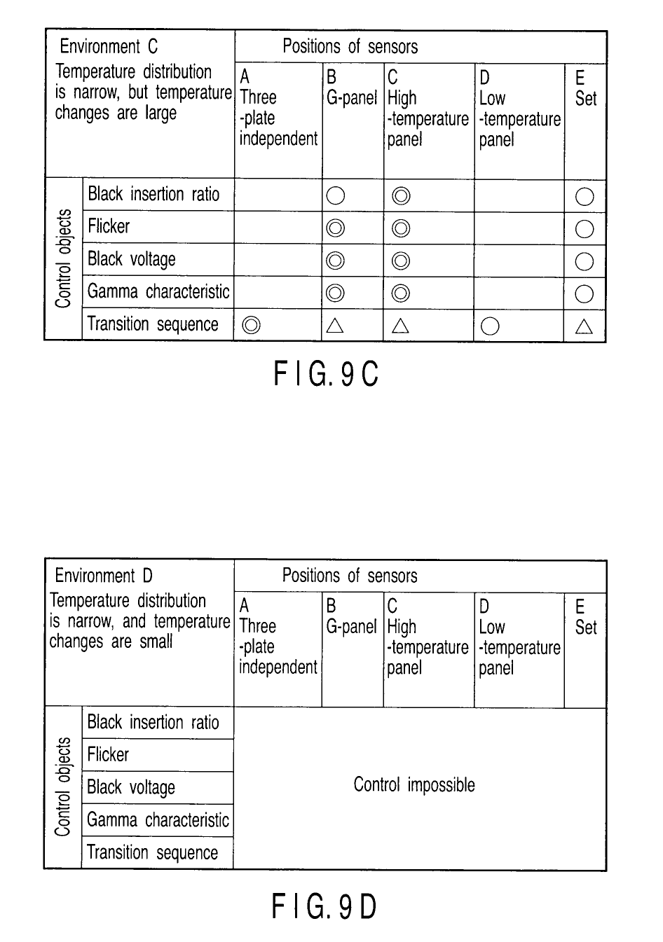

FIGS. 9A to 9D are tables representing the compatibility the various control methods may have with the various control objects, in environments A to C, respectively.

In FIGS. 9A to 9D, a \textcircled{◯} mark indicates that the control method is appropriate for a particular object in a specific environment; a ◯ mark indicates that the control method can be applied to a particular object in a specific environment; and a Δ mark indicates that a control method may be used to control a particular object in a specific environment if any other method are inappropriate for the object. Any method with no mark is one inappropriate for a particular object in a specific environment.

The results shown in FIGS. 9A to 9D can be utilized in designing the projection system, in accordance with the environment in which the system is used by the user.

The configuration of a liquid-crystal display panel using this control method will be described below.

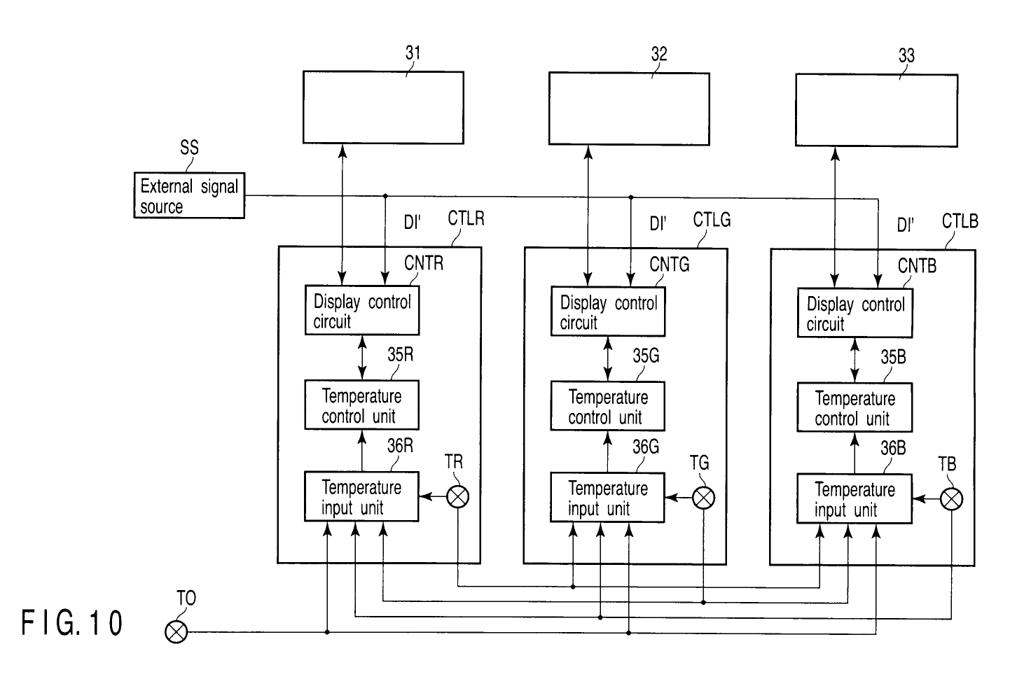

FIG. 10 is a diagram showing the configuration of a liquid-crystal display for use in a projection system.

This liquid-crystal display comprises transmission-type liquid-crystal panels 31, 32 and 33 and control units CTLR, CTLG and CTLB. The control units CTLR, CTLG and CTLB control the liquid-crystal panels 31, 32 and 33, respectively, and perform the control on the various objects specified above, in accordance with the temperature.

An external signal source SS and a temperature sensor TO, both provided outside the liquid-crystal display, are connected to the liquid-crystal panels 31, 32 and 33. The external signal source SS supplies an image data DI′ to the control units CTLR, CTLG and CTLB.

The control units CTLR, CTLG and CTLB have the same configuration. Therefore, only the control unit CTLR will be described.

The control unit CTLR comprises a display control circuit CNTR, a temperature control unit 35R, a temperature input unit 36R, and a temperature sensor TR.

The display control circuit CNTR is identical in configuration to the display control circuit CNT shown in FIG. 1. Therefore, the display control circuit CNTR will not be described in detail. The temperature input unit 36R is connected to the temperature sensors TR, TG, TB and TO and can therefore read the values the temperature sensor TR, TG, TB and TO have measured. The temperature control unit 35R calculates control values that should be applied to the objects, respectively, and receives and supplies data from and to the display control circuit CNTR. The temperature sensor TR measures the temperature of the liquid-crystal panel 31. Note that the liquid-crystal panel 31 is connected to the control units CTLG and CTLB.

How the control unit CTLR operates will be explained below.

The temperature input unit 36R reads, at regular intervals, the values measured by the temperature sensor TR, TG, TB and TO read. The values read are output to the temperature control unit 35R.

The temperature control unit 35R has a table showing various control methods, each considered most appropriate for controlling a specific object (see FIGS. 9A to 9D). The table can be rewritten, but it initially shows the control methods described by the manufacturer of the projection system. The temperature control unit 35R refers to the table, designating the temperature sensor or sensors that should be used, and then calculates control values from the temperatures the sensors designated have measured. At a prescribed timing, the control unit 35R exchange signals with the display control circuit CNTR, and performs the control.

Note that the configuration of the control units CTLR, CTLG and CTLB is not limited to the one described above. Rather, they can have any one of other various configurations.

The outputs of the temperature sensor TR, TG, TB and TO are input in parallel to the control units CTLR, CTLG and CTLB. Alternatively, the control units CTLR, CTLG and CTLB may be connected by a communications line so that each may receive and supply temperature values from and to any other control unit. In this embodiment, tables relating to the temperature control are stored in each control units CTLR, CTLG and CTLB, but such tables may be stored in a memory common to control units CTLR, CTLG and CTLB.

Some embodiments of the projection systems, each incorporating liquid-crystal displays of the type described above.

### (1) Mobile Projection System

In any projection system configured portable, the liquid-crystal displays are arranged so close to one another that the temperature distribution is narrow. In addition, the temperature may greatly change because the system is moved from one place to another and inevitably used in various environments. Hence, the temperature environment of the projection system corresponds to “environment C” shown in FIG. 9C.

In this case, the control employed is the “high-temperature panel” control. In the above-mentioned table, it is described that the high-temperature panel control should be utilized. As a result, the temperature control units 35R, 35G and 35B control the temperatures of the liquid-crystal panels 31, 32 and 33, respectively, in accordance with the highest of the three temperatures detected by the temperature sensor TR, TG and TB.

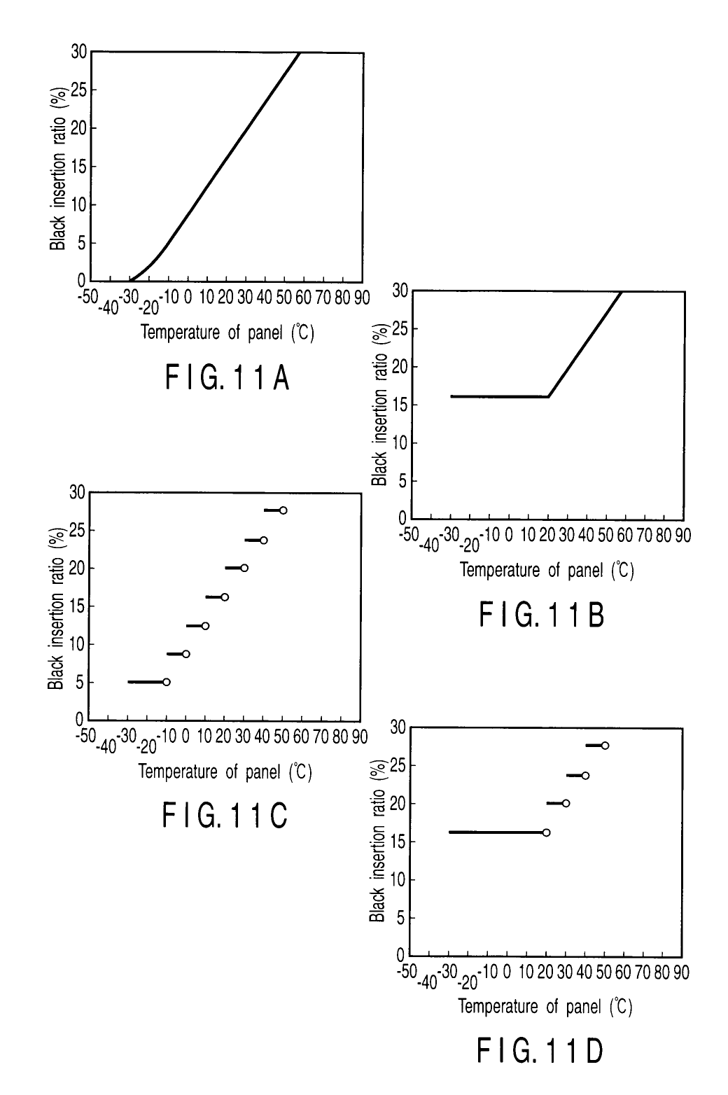

FIGS. 11A to 11D are diagrams showing various relationships the black insertion ratio may have with the temperature.

As can be seen from FIGS. 11A to 11D, the black insertion ratio may changed, either continuously or discretely. The black insertion ratio can be changed by changing, for example, the timing of inputting the first start signal (gradation display start signal) STHA and second start signal (black insertion start signal) STHB.

### (2) Large-Scale Projection System

In any large-scale projection system for use in auditoriums capable of holding a large audience, each liquid-crystal display is positioned far from the other liquid-crystal display. Therefore, the temperature distribution in each liquid-crystal display is broad. Since the display is set in a temperature-stable environment, the liquid-crystal panels are considered to undergo only a little temperature change. Hence, the temperature environment of this projection system corresponds to “environment B” shown in FIG. 9B.

In this case, the “G-panel” sensor control is therefore employed. In the above-mentioned table, it is described that the high-temperature panel control should be utilized. As a result, the temperature control units 35R, 35G and 35B execute the temperature control of the liquid-crystal panels 31, 32 and 33, respectively, in accordance with the temperature detected by the temperature sensor TG.

### (3) Outdoor Projection System

In any outdoor projection system for use in the open, where many people get together, each liquid-crystal display is positioned far from the other liquid-crystal display. Therefore, the temperature distribution is broad in each liquid-crystal display. Since the display is set in the open, the liquid-crystal panels are considered to undergo a large temperature change. Hence, the temperature environment of the outdoor projection system corresponds to “environment A” shown in FIG. 9A.

Therefore, the “high-temperature panel” sensor control and the “low-temperature panel” sensor control are employed. Thus, in the above-mentioned table, it is described that the high-temperature panel sensor control and the low-temperature panel should be utilized. As a result, the temperature control units 35R, 35G and 35B control the black insertion ratio, flicker, black voltage and gamma, in accordance with the highest of the three temperatures detected by the temperature sensor TR, TG and TB, and control the transition sequence in accordance with the lowest of the three temperatures detected by the temperature sensor TR, TG and TB.

How to correct the black voltage will be explained.

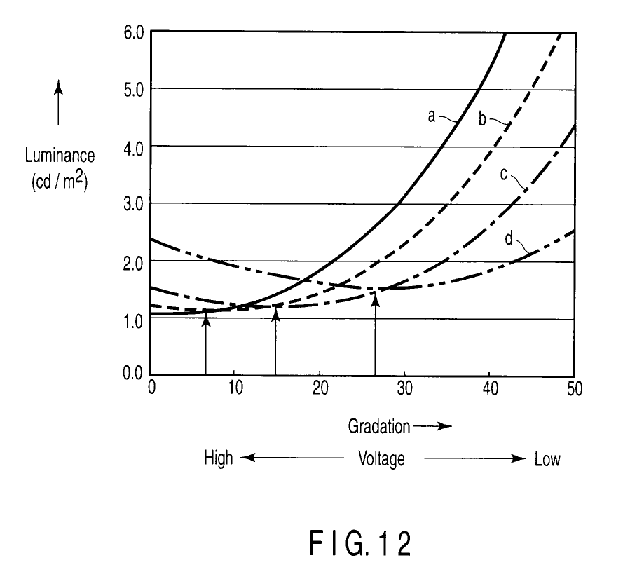

FIG. 12 is a diagram representing the relationship between temperature and transmittance. In FIG. 12, the gradation is plotted on the abscissa, and the luminance is plotted on the ordinate. In FIG. 12, line a indicates the relationship observed when the temperature is 20° C., line b indicates the relationship observed when the temperature is 40° C., line c indicates the relationship observed when the temperature is 60° C., and line d indicates the relationship observed when the temperature is 80° C. As can be understood from FIG. 12, the higher the temperature, the lower the voltage at which the luminance is the lowest.

Therefore, the gradation reference voltage is controlled, lowering the black voltage if the temperature is higher than a reference value, and raising the black voltage if the temperature is lower than the reference value. Thus, the black voltage is set to the optimal value, whereby the contrast reduction is suppressed.

How to correct the gamma characteristic will be explained.

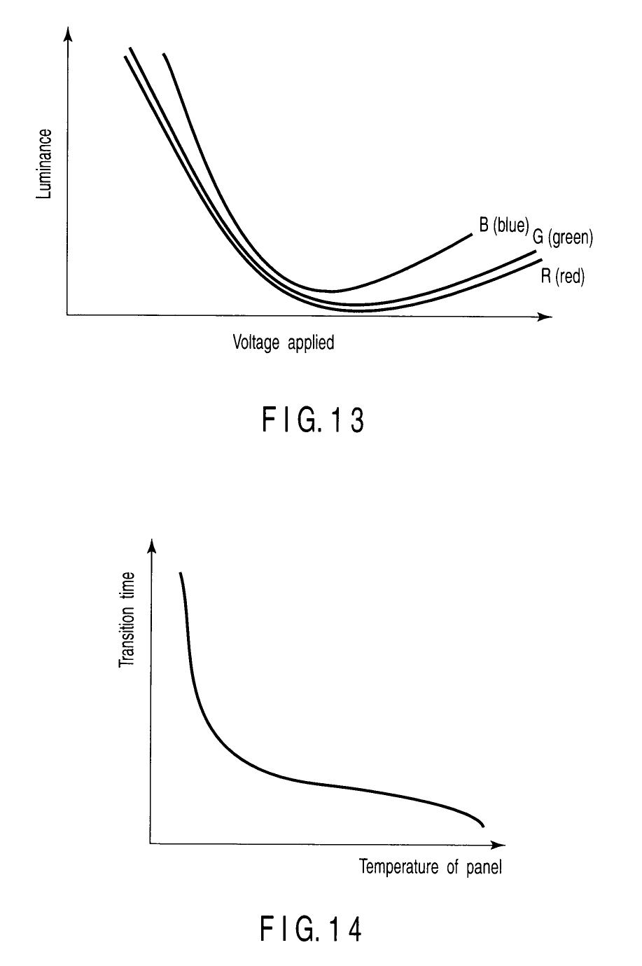

FIG. 13 is a diagram representing luminance-voltage characteristic data, i.e., the relationship between the luminance of an image displayed by OCB-mode liquid-crystal and the voltage applied to the OCB-mode liquid-crystal. Based on this luminance-voltage characteristic data, the image signal is converted to a voltage. This voltage is applied to the OCB-mode liquid-crystal. The luminance-voltage characteristic data is rewritten whenever the temperatures of the panels change.

In the liquid-crystal display so configured as described above, at least one of the blue gamma characteristic, red gamma characteristic and green gamma characteristic included in the luminance-voltage characteristic data can be rewritten when the temperatures of the panels change. The image contrast at, for example, high temperature can therefore be prevented.

How to control the transition sequence will be explained.

FIG. 14 is a diagram representing the relationship between the panel temperature and the transition time. As seen from FIG. 14, the alignment transition undergoes within a relatively short time if the panels have high temperatures. If the panels have low temperatures, a long time is required to achieve alignment transition. In view of this, the temperature of each panel may be measured, and the time of applying the transition voltage may be changed in accordance with the temperature. The alignment of the liquid-crystal can thereby be reliably changed from splay alignment to bend alignment.

The embodiments described above are three-plate, transmission-type projection systems. The present invention is not limited to projection systems of this type. The projection system of this invention may have a reflective-type liquid-crystal display or a transflective liquid-crystal display. Moreover, the projection system according to the present invention may be other than a three-plate, transmission-type projection system.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A projection system which has a plurality of liquid-crystal displays each comprising a display panel having a plurality of OCB-mode liquid-crystal pixels, and a control unit configured to control the display panel, and which synthesizes images of different colors, modulated by the display panels, thereby to display a color image,
wherein each of the liquid-crystal displays includes a temperature sensor, and the control unit of each liquid-crystal display controls at least one condition of driving the display panel in accordance with the temperature detected by one of the temperature sensors.

2. The projection system according to claim 1, wherein the control unit of each liquid-crystal display controls at least one condition of driving the display panel in accordance with the temperature detected by a temperature sensor of said each liquid-crystal display.

3. The projection system according to claim 1, wherein the control unit of each liquid-crystal display controls at least one condition of driving the display panel in accordance with the temperature detected by the temperature sensor provided on the liquid-crystal display that modulates an image of a specific color.

4. The projection system according to claim 3, wherein the specific color is green.

5. The projection system according to claim 1, wherein the control unit of each liquid-crystal display controls at least one condition of driving the display panel in accordance with a maximal value of the temperatures detected by the temperature sensors.

6. The projection system according to claim 1, wherein the control unit of each liquid-crystal display controls at least one condition of driving the display panel in accordance with a minimal value of the temperatures detected by the temperature sensors.

7. The projection system according to claim 1, wherein the condition of driving the display panel is at least one item selected from the group consisting of black insertion ratio, flicker, black voltage, gamma characteristic and transition sequence.

8. The projection system according to claim 7, wherein when the condition of driving the display panel is the black insertion ratio, the control unit of each liquid-crystal display controls at least one condition in accordance with a maximal value of the temperatures detected by the temperature sensors.

9. The projection system according to claim 7, wherein when the condition of driving the display panel is the transition sequence, the control unit of each liquid-crystal display controls at least one condition in accordance with the temperature detected by the temperature sensor of the liquid-crystal display or a minimal value of the temperatures detected by the temperature sensors.

10. The projection system according to claim 7, wherein when the condition of driving the display panel is the black voltage, flicker or gamma characteristic, the control unit of each liquid-crystal display controls at least one condition in accordance with the temperature sensor provided on the liquid-crystal display that modulates a green image or with a minimal value of the temperatures detected by the temperature sensors.

11. A projection system which has a plurality of liquid-crystal displays each comprising a display panel having a plurality of OCB-mode liquid-crystal pixels, and a control unit, and which synthesizes images of different colors, modulated by the display panels, thereby to display a color image,
wherein the control unit of each liquid-crystal display controls at least one condition of driving the display panel in accordance with the temperature detected by a temperature sensor provided outside the liquid-crystal displays.

12. A projection system which has a plurality of liquid-crystal displays each comprising a display panel having a plurality of OCB-mode liquid-crystal pixels, and a control unit configured to control the display panels, and which synthesizes images of different colors, modulated by the display panels, thereby to display a color image,
wherein one of the liquid-crystal displays includes a temperature sensor, and the control unit of each liquid-crystal display controls at least one condition of driving the display panel in accordance with the temperature detected by the temperature sensor.
